(19) United States
(12) Patent Application Publication
(10) Pub. No.: US 2007/0068785 A1
(43) Pub. Date: Mar. 29, 2007

(54) Rocker level assembly

(75) Inventor: Mei-Hsiu Lee, Tao Yuan City (TW)

Correspondence Address: NIKOLAI & MERSEREAU, P.A., 900 SECOND AVENUE SOUTH, SUITE 820, MINNEAPOLIS, MN, 55402, US

(73) Assignee: Taiwan PWL Corporation, Tao Yuan City (TW)

(21) Appl. No.: 11/235,719

(22) Filed: Sep. 26, 2005

(51) Int. Cl. H01H 13/00

(52) U.S. Cl. 200/339

(57) ABSTRACT

A rocker lever assembly includes a base having a first side formed with a receiving space, a circuit board mounted on the first side of the base, a press cover mounted on a second side of the base, a displacement device mounted in the receiving space of the base, and a control lever mounted between the base and the press cover and connected to the displacement device to move the displacement device. Thus, the longitudinal lever and the transverse lever of the displacement device are mounted in the receiving space of the base so that the longitudinal size of the rocker lever assembly is reduced largely, thereby greatly shortening the whole volume of the rocker lever assembly.

### BACKGROUND OF THE INVENTION

1. Field of the Invention

The present invention relates to a rocker lever assembly for a potentiometer, and more particularly to a rocker lever assembly having a control lever to control movement of a plurality of electrical elements.

2. Description of the Related Art

A conventional rocker lever comprises a housing, an operation device mounted in the housing, a switch device mounted on an outside of the housing, a restoring device mounted in the housing, and two variable resistors mounted on an outside of the housing. The operation device includes a first pivot seat pivotable in a longitudinal direction, a second pivot seat pivotable in a transverse direction perpendicular to that of the first pivot seat, and a control lever movable in the longitudinal direction and the transverse direction to pivot the first pivot seat and the second pivot seat in the longitudinal direction and the transverse direction respectively. When in use, the conventional rocker lever is available for controlling the navigation direction or data change of a personal digital product, such as the PDA, video game, cell phone, portable computer or the like. However, the conventional rocker lever has a greater longitudinal size, thereby greatly increasing the whole volume of the rocker lever.

### SUMMARY OF THE INVENTION

In accordance with the present invention, there is provided a rocker lever assembly, comprising a base having a first side formed with a receiving space, a circuit board mounted on the first side of the base, a press cover mounted on a second side of the base, a displacement device mounted in the receiving space of the base, and a control lever mounted between the base and the press cover and connected to the displacement device to move the displacement device.

The primary objective of the present invention is to provide a rocker lever assembly having a miniature and thin size.

Another objective of the present invention is to provide a rocker lever assembly, wherein the longitudinal lever and the transverse lever of the displacement device are mounted in the receiving space of the base so that the longitudinal size of the rocker lever assembly is reduced largely, thereby greatly shortening the whole volume of the rocker lever assembly.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a rocker lever assembly in accordance with the preferred embodiment of the present invention.

FIG. 2 is an exploded perspective view of the rocker lever assembly in accordance with the preferred embodiment of the present invention.

FIG. 3 is a locally enlarged perspective view of a control lever of the rocker lever assembly as shown in FIG. 2.

FIG. 4 is a perspective assembly view of the rocker lever assembly in accordance with the preferred embodiment of the present invention.

FIG. 5 is a plan cross-sectional view of the rocker lever assembly as shown in FIG. 4.

FIG. 6 is a plan cross-sectional view of the rocker lever assembly as shown in FIG. 4.

### DETAILED DESCRIPTION OF THE INVENTION

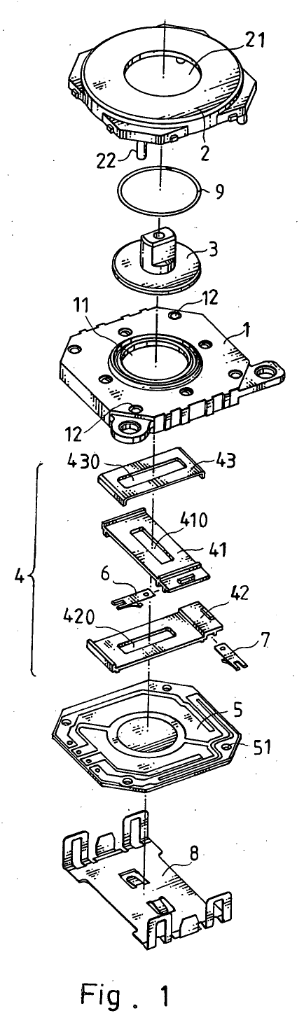

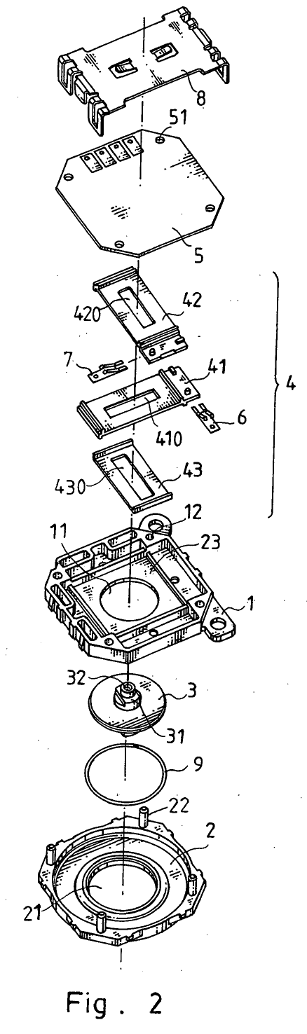

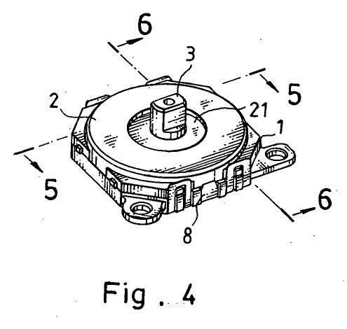

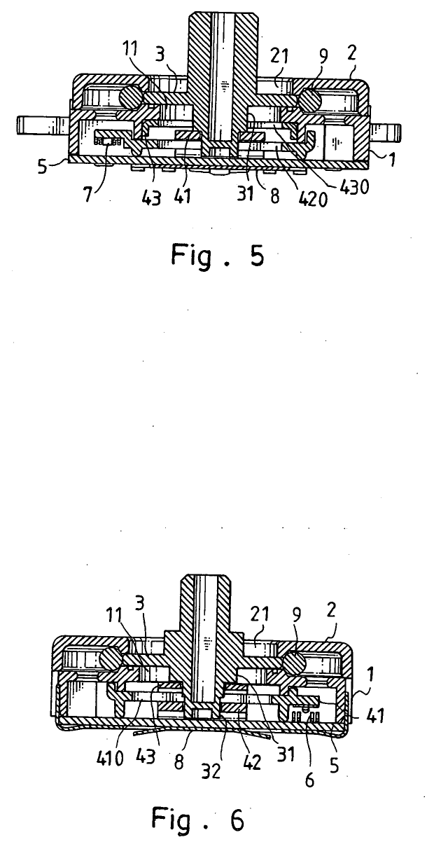

Referring to FIGS. 1-6, a rocker lever assembly in accordance with the preferred embodiment of the present invention is available for controlling the navigation direction or data change of a personal digital product, such as a PDA, video game, cell phone, portable notebook computer or the like, and comprises a base 1 having a first side formed with a receiving space 13, a circuit board 5 mounted on the first side of the base 1, a press cover 2 mounted on a second side of the base 1, a displacement device 4 mounted in the receiving space 13 of the base 1, a control lever 3 mounted between the base 1 and the press cover 2 and connected to the displacement device 4 to move the displacement device 4, a restoring device 9 mounted between the control lever 3 and the press cover 2, a cover plate 8 mounted on the first side of the base 1 and rested on the circuit board 5 to secure the circuit board 5 to the base 1, and at least one electrical element integrated on the circuit board 5 and contacting with the displacement device 4.

The base 1 has a through hole 11 to allow passage of the control lever 3, and the receiving space 13 of the base 1 is connected to the through hole 11 of the base 1. The base 1 has a periphery formed with a plurality of fixing holes 12.

The press cover 2 has a through hole 21 to allow passage of the control lever 3. The press cover 2 has a periphery formed with a plurality of protruding fixing posts 22 inserted into and fixed in the fixing holes 12 of the base 1 so that the press cover 2 is secured to the base 1 easily and rapidly.

The displacement device 4 is mounted between the base 1 and the circuit board 5 and includes a longitudinal lever 41 mounted in the receiving space 13 of the base 1, a transverse lever 42 mounted in the receiving space 13 of the base 1 and located perpendicular to the longitudinal lever 41, and a limit plate 43 mounted in the receiving space 13 of the base 1 and connected to the control lever 3 to prevent rotation of the control lever 3. The longitudinal lever 41 of the displacement device 4 has an elongated guide slot 410, and the transverse lever 42 of the displacement device 4 has an elongated guide slot 420. The limit plate 43 of the displacement device 4 has an elongated limit slot 430. The longitudinal lever 41 of the displacement device 4 has a contact end provided with a longitudinal carbon brush 6 slidably contacting with the electrical element on the circuit board 5, and the transverse lever 42 of the displacement device 4 has a contact end provided with a transverse carbon brush 7 slidably contacting with the electrical element on the circuit board 5.

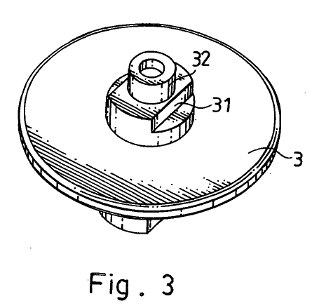

The control lever 3 is mounted in a spaced formed between the base 1 and the press cover 2. As shown in FIG. 3, the control lever 3 has an end portion formed with a protruding limit block 31 limited in the limit slot 430 of the limit plate 43 of the displacement device 4 to prevent the control lever 3 from being rotatable relative to the displacement device 4. The limit block 31 of the control lever 3 has an end face formed with a protruding guide post 32 extended through and movably mounted in the guide slot 410 of the longitudinal lever 41 of the displacement device 4 and the guide slot 420 of the transverse lever 42 of the displacement device 4.

The circuit board 5 has a periphery formed with a plurality of through holes 51 to allow passage of the fixing posts 22 of the press cover 2 so that the circuit board 5 is secured to the first side of the base 1.

The restoring device 9 provides a restoring effect to the control lever 3 so that the control lever 3 is restored to the original state automatically. The restoring device 9 is a ring-shaped spring mounted on the control lever 3 and having two ends connected with each other.

Accordingly, the longitudinal lever 41 and the transverse lever 42 of the displacement device 4 are mounted in the receiving space 13 of the base 1 so that the longitudinal size of the rocker lever assembly is reduced largely, thereby greatly shortening the whole volume of the rocker lever assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A rocker lever assembly, comprising:
a base having a first side formed with a receiving space;
a circuit board mounted on the first side of the base;
a press cover mounted on a second side of the base;
a displacement device mounted in the receiving space of the base;
a control lever mounted between the base and the press cover and connected to the displacement device to move the displacement device.

2. The rocker lever assembly in accordance with claim 1, wherein the base has a through hole to allow passage of the control lever, and the receiving space of the base is connected to the through hole of the base.

3. The rocker lever assembly in accordance with claim 1, wherein the press cover has a through hole to allow passage of the control lever.

4. The rocker lever assembly in accordance with claim 1, wherein the base has a periphery formed with a plurality of fixing holes, and the press cover has a periphery formed with a plurality of protruding fixing posts inserted into and fixed in the fixing holes of the base so that the press cover is secured to the base.

5. The rocker lever assembly in accordance with claim 4, wherein the circuit board has a periphery formed with a plurality of through holes to allow passage of the fixing posts of the press cover so that the circuit board is secured to the first side of the base.

6. The rocker lever assembly in accordance with claim 1, wherein the displacement device is mounted between the base and the circuit board and includes a longitudinal lever mounted in the receiving space of the base, a transverse lever mounted in the receiving space of the base and located perpendicular to the longitudinal lever, and a limit plate mounted in the receiving space of the base and connected to the control lever to prevent rotation of the control lever.

7. The rocker lever assembly in accordance with claim 6, wherein the limit plate of the displacement device has an elongated limit slot, and the control lever has an end portion formed with a protruding limit block limited in the limit slot of the limit plate of the displacement device to prevent the control lever from being rotatable relative to the displacement device.

8. The rocker lever assembly in accordance with claim 7, wherein the longitudinal lever of the displacement device has an elongated guide slot, the transverse lever of the displacement device has an elongated guide slot, and the limit block of the control lever has an end face formed with a protruding guide post extended through and movably mounted in the guide slot of the longitudinal lever of the displacement device and the guide slot of the transverse lever of the displacement device.

9. The rocker lever assembly in accordance with claim 1, further comprising a cover plate mounted on the first side of the base and rested on the circuit board to secure the circuit board to the base.

10. The rocker lever assembly in accordance with claim 1, further comprising at least one electrical element integrated on the circuit board and contacting with the displacement device.

11. The rocker lever assembly in accordance with claim 10, wherein the longitudinal lever of the displacement device has a contact end provided with a longitudinal carbon brush slidably contacting with the electrical element on the circuit board, and the transverse lever of the displacement device has a contact end provided with a transverse carbon brush slidably contacting with the electrical element on the circuit board.

12. The rocker lever assembly in accordance with claim 1, further comprising a restoring device mounted between the control lever and the press cover to provide a restoring effect to the control lever so that the control lever is restored to the original state automatically.

13. The rocker lever assembly in accordance with claim 12, wherein the restoring device is a ring-shaped spring having two ends connected with each other.

14. The rocker lever assembly in accordance with claim 12, wherein the restoring device is mounted on the control lever.

15. The rocker lever assembly in accordance with claim 1, wherein the control lever is mounted in a spaced formed between the base and the press cover.
